(19) United States
(12) Patent Application Publication
(10) Pub. No.: US 2009/0153548 A1
(43) Pub. Date: Jun. 18, 2009

(54) METHOD AND SYSTEM FOR SLICE ALIGNMENT IN DIAGNOSTIC IMAGING SYSTEMS

(76) Inventors: Stein Inge Rabben, Sofiemyr (NO); Sevald Berg, Horton (NO)

Correspondence Address: DEAN D. SMALL;THE SMALL PATENT LAW GROUP LLP, 225 S. MERAMEC, STE. 725T, ST. LOUIS, MO, 63105, US

(21) Appl. No.: 11/938,370

(22) Filed: Nov. 12, 2007

(51) Int. Cl. G06T 15/00; G06K 9/00

(52) U.S. Cl. 345/419; 382/128

(57) ABSTRACT

A method and system for slice alignment in multiple image views are provided. The method includes determining an adjustment of one of a plurality of image views to align an imaged object with at least one alignment marker. The method further includes updating the plurality of image views based on the adjustment. The updating includes at least one of rotating and translating the image views with respect to an intersection of the at least one alignment marker with another alignment marker.

### BACKGROUND OF THE INVENTION

This invention relates generally to diagnostic imaging systems, and more particularly, to methods for aligning slice planes, especially to multiple cardiac views, within volumetric data.

Medical imaging systems are used in different applications to image different regions or areas (e.g., different organs) of patients. For example, ultrasound systems are finding use in an increasing number of applications, such as to generate images of the heart. These images are then displayed for review and analysis by a user. The images also may be modified or adjusted to better view or visualize different regions or objects of interest, such as different views of the heart.

Navigation within a volumetric data set is often challenging for a user and results in a time consuming and tedious process when, for example, attempting to display different views of an organ of interest. A user is typically able to adjust slicing planes that cut into the imaged object within the volumetric data such that multiple views through the imaged object may be displayed.

In volume imaging, another important functionality is the ability to crop parts of the imaged object in order to look inside the object. The crop function can be performed in different ways. Cropping is commonly performed by defining a plane that cuts into the imaged object and the part of the object on one side of that plane is removed from the rendering.

When visualizing objects using volume imaging, such as when visualizing object within a volumetric ultrasound data set, challenges arise. For example, a challenge with visualization of the human heart using volume ultrasound is to navigate slicing planes within the volumetric data and identify anatomical structures in order to produce clinically relevant views. Typically, an operator manually defines single rendering views by cutting the volume at random locations with no relation to other previously defined views. For example, an operator generates one view of a heart by cropping the image to generate a single view and then rotating and/or translating the image to another view and then cropping the image again at another location to generate another view. This process is repeated until multiple different images defining different views are generated. For example, slicing planes may be rotated and translated within an ultrasound volume to generate standard views (e.g., standard apical views) for analysis. A user may often experience difficulty finding the different views to be displayed.

Thus, the process to generate different views of an imaged object is tedious and time consuming. Additionally, the views generated may not capture the correct region or regions of interest, thereby potentially resulting in excluding clinically relevant information and possible improper diagnosis. Further, the views generated may not be properly aligned to relevant anatomical structures, thereby resulting in difficulty in viewing and analysis.

### BRIEF DESCRIPTION OF THE INVENTION

In accordance with an embodiment of the invention, a method for slice alignment in a volumetric data set is provided. The method includes determining an adjustment of one of a plurality of image views to align an imaged object with at least one alignment marker. The method further includes updating the plurality of image views based on the adjustment. The updating includes at least one of rotating and translating the image views with respect to an intersection of the at least one alignment marker with another alignment marker.

In accordance with another embodiment of the invention, a method for slice alignment in a volumetric data set of an imaged heart is provided. The method includes displaying a plurality of apical views of the heart in combination with a plurality of alignment markers and displaying a plurality of short axis views of the heart. The method further includes updating the plurality of apical views and short axis views based on a user identified center point in at least two of the short axis apical views.

In accordance with yet another embodiment of the invention, a method for slice alignment in a volumetric data set of an imaged heart is provided. The method includes displaying a plurality of apical views of the heart in combination with a plurality of alignment markers and updating the plurality of apical views based on user identified landmarks.

In accordance with still another embodiment of the invention, an ultrasound system is provided that includes an ultrasound probe for acquiring a volumetric ultrasound data set of a heart. The ultrasound system further includes a processor having a slice alignment module configured to automatically align a plurality of views of the volumetric data set based on at least one of (i) a centerline alignment marker and a perpendicular intersection marker rotated about the intersection of the centerline marker and the perpendicular intersection marker in one of a 4-chamber apical view of the heart, a 2-chamber apical view of the heart and a long axis apical view of the heart, (ii) an identified center point in at least two short axis apical views of the heart, (iii) an identified left ventricular outlet tract in a short axis apical view of the heart, and (iv) a plurality of identified landmarks corresponding to a mitral annulus and an apex of a left ventricle of the heart.

### BRIEF DESCRIPTION OF THE DRAWINGS

FIG. 1 is a block diagram of an ultrasound system formed in accordance with an embodiment of the present invention.

FIG. 2 illustrates a 3D-capable miniaturized ultrasound system formed in accordance with an embodiment of the present invention.

FIG. 3 illustrates a hand carried or pocket-sized ultrasound imaging system formed in accordance with an embodiment of the present invention.

FIG. 4 illustrates a console type ultrasound imaging system formed in accordance with an embodiment of the present invention.

FIG. 5 is a flowchart for aligning slices to different views of an imaged volume within a volumetric data set in accordance with various embodiments of the invention.

FIG. 6 is a display illustrating slice alignment in accordance with an embodiment of the invention using a centerline maker.

FIG. 7 is a display illustrating slice alignment in accordance with an embodiment of the invention using a center point in a plurality of image views.

FIG. 8 is a display illustrating slice alignment in accordance with an embodiment of the invention using identified anatomical landmarks.

FIG. 9 is a display illustrating slice alignment in accordance with an embodiment of the invention using an identified left ventricular outlet tract.

FIG. 10 is another display illustrating slice alignment in accordance with an embodiment of the invention using identified anatomical landmarks.

FIG. 11 is another display illustrating slice alignment in accordance with an embodiment of the invention using identified anatomical landmarks.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

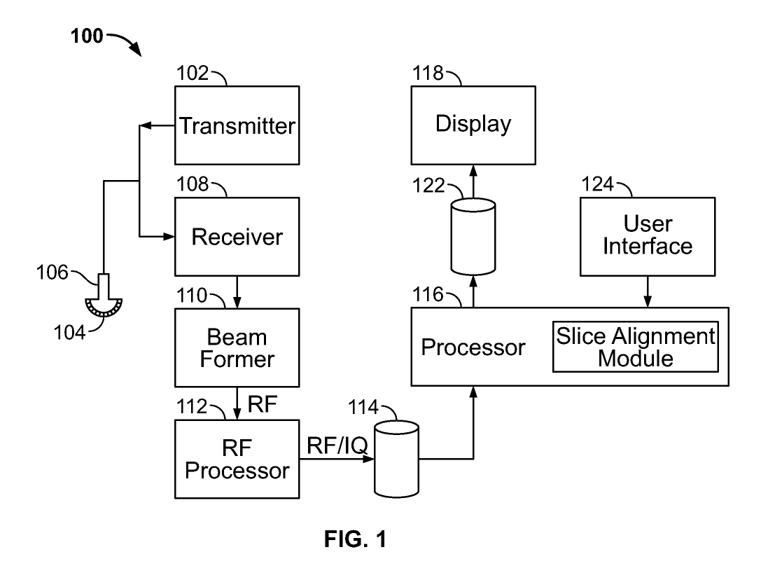

FIG. 1 is a block diagram of an ultrasound system 100 constructed in accordance with various embodiments of the invention that includes a transmitter 102 that drives an array of elements 104 (e.g., piezoelectric elements) within a probe 106 to emit pulsed ultrasonic signals into a body. A variety of geometries may be used. The ultrasonic signals are back-scattered from structures in the body, like blood cells or muscular tissue, to produce echoes that return to the elements 104. The echoes are received by a receiver 108. The received echoes are passed through a beamformer 110, which performs beamforming and outputs an RF signal. The RF signal then passes through an RF processor 112. Alternatively, the RF processor 112 may include a complex demodulator (not shown) that demodulates the RF signal to form IQ data pairs representative of the echo signals. The RF or IQ signal data may then be routed directly to a memory 114 for storage.

The ultrasound system 100 also includes a processor 116 to process the acquired ultrasound information (e.g., RF signal data or IQ data pairs) and prepare frames of ultrasound information for display on display 118. The processor 116 is adapted to perform one or more processing operations according to a plurality of selectable ultrasound modalities on the acquired ultrasound data. Acquired ultrasound data may be processed and displayed in real-time during a scanning session as the echo signals are received. Additionally or alternatively, the ultrasound data may be stored temporarily in memory 114 during a scanning session and then processed and displayed in an off-line operation.

The processor 116 is connected to a user interface 124 that may control operation of the processor 116 as explained below in more detail. The processor 116 also includes a slice alignment module 126 that aligns slicing planes within a volumetric data set based on received user inputs from the user interface 124. For example, the slice alignment module aligns slicing planes within the volumetric data set based on user adjustments and that may be used to align different views for display on the display 118, such as, standard two-dimensional (2D) views of the heart. The alignment information of the imaged object within the volumetric data set also may be input to other three-dimensional (3D) applications such as to perform volume measurements and to generate volume renderings with cropping planes aligned to standard views of the heart.

The display 118 includes one or more monitors that present patient information, including diagnostic ultrasound images to the user for diagnosis and analysis (e.g., standard apical views of the heart). One or both of memory 114 and memory 122 may store three-dimensional data sets of the ultrasound data, where such 3D data sets are accessed to present 2D and 3D images as described herein. The images may be modified and the display settings of the display 118 also manually adjusted using the user interface 124.

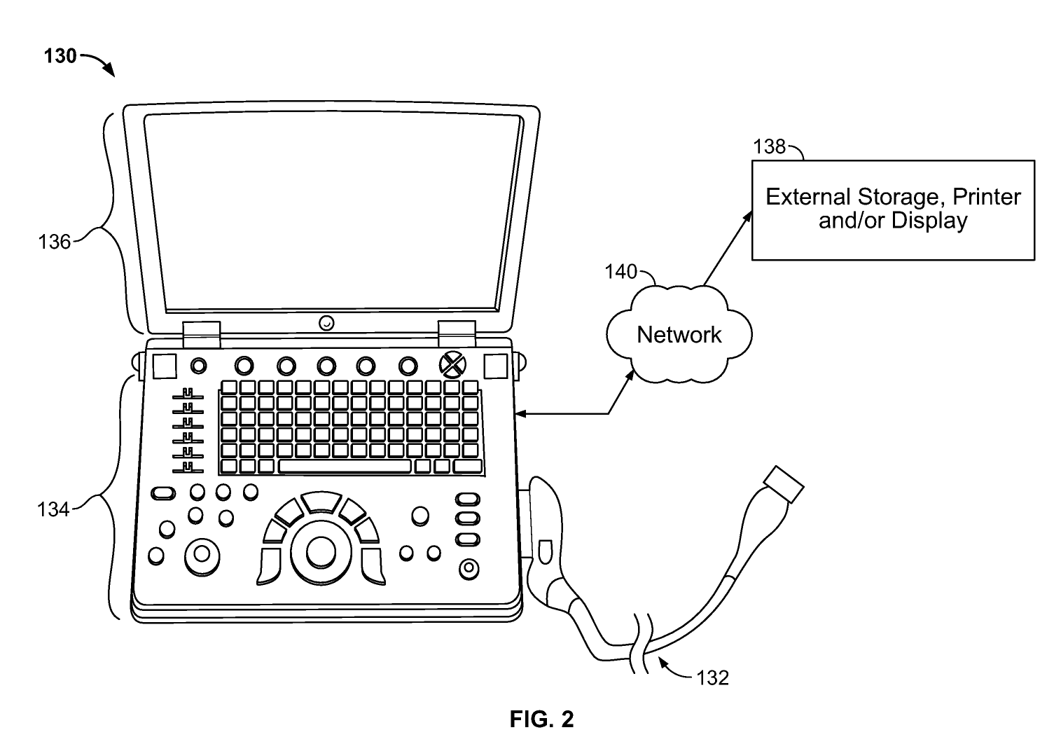

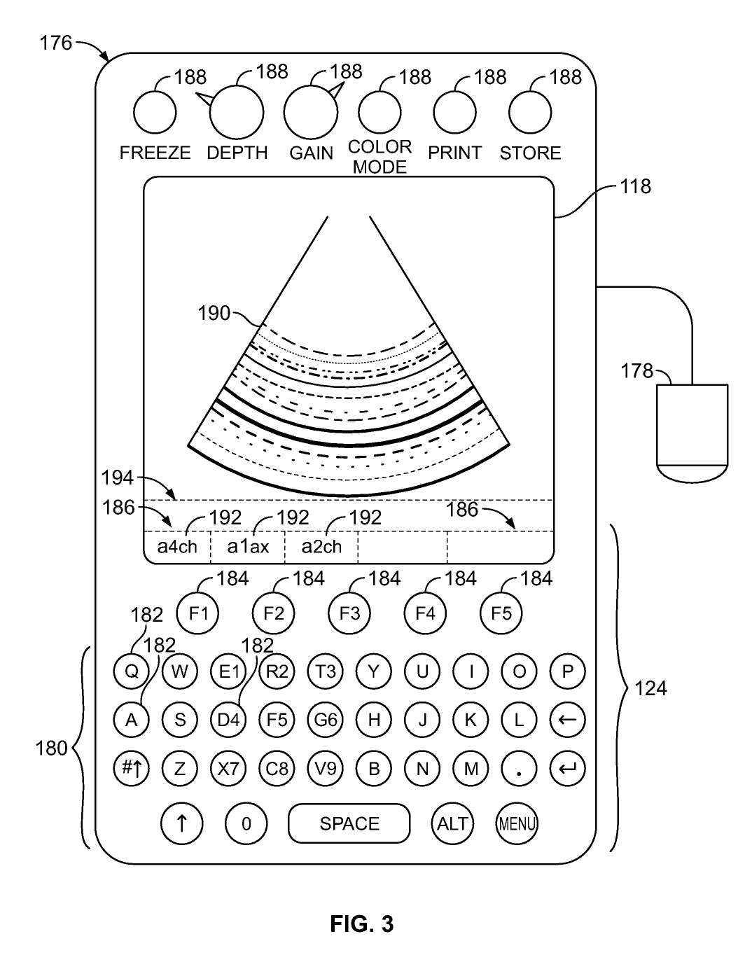

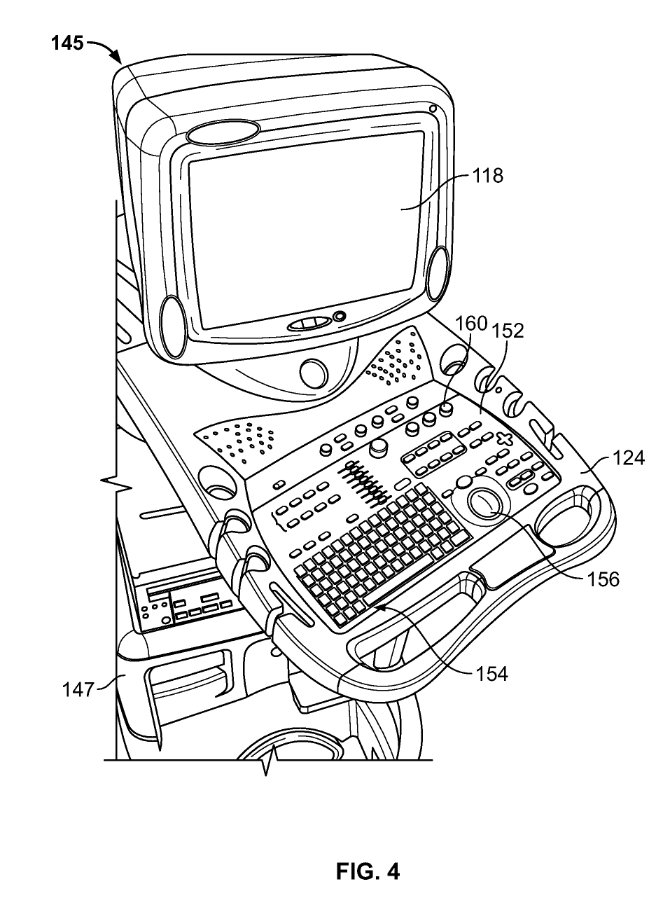

The generalized ultrasound system 100 of FIG. 1 may be embodied in a small-sized system, such as laptop computer or pocket sized system as well as in a larger console-type system. FIGS. 2 and 3 illustrate small-sized systems, while FIG. 4 illustrates a larger system.

FIG. 2 illustrates a 3D-capable miniaturized ultrasound system 130 having a probe 132 that may be configured to acquire 3D ultrasonic data. For example, the probe 132 may have a 2D array of elements 104 as discussed previously with respect to the probe 106 of FIG. 1. A user interface 134 (that may also include an integrated display 136) is provided to receive commands from an operator. As used herein, “miniaturized” means that the ultrasound system 130 is a handheld or hand-carried device or is configured to be carried in a person's hand, pocket, briefcase-sized case, or backpack. For example, the ultrasound system 130 may be a hand-carried device having a size of a typical laptop computer. The ultrasound system 130 is easily portable by the operator. The integrated display 136 (e.g., an internal display) is configured to display, for example, one or more medical images.

The ultrasonic data may be sent to an external device 138 via a wired or wireless network 140 (or direct connection, for example, via a serial or parallel cable or USB port). In some embodiments, the external device 138 may be a computer or a workstation having a display. Alternatively, the external device 138 may be a separate external display or a printer capable of receiving image data from the hand carried ultrasound system 130 and of displaying or printing images that may have greater resolution than the integrated display 136.

FIG. 3 illustrates a hand carried or pocket-sized ultrasound imaging system 176 wherein the display 118 and user interface 124 form a single unit. By way of example, the pocket-sized ultrasound imaging system 176 may be a pocket-sized or hand-sized ultrasound system approximately 2 inches wide, approximately 4 inches in length, and approximately 0.5 inches in depth and weighs less than 3 ounces. The pocket-sized ultrasound imaging system 176 generally includes the display 118, user interface 124, which may or may not include a keyboard-type interface and an input/output (I/O) port for connection to a scanning device, for example, an ultrasound probe 178. The display 118 may be, for example, a 320×320 pixel color LCD display (on which a medical image 190 may be displayed). A typewriter-like keyboard 180 of buttons 182 may optionally be included in the user interface 124.

Multi-function controls 184 may each be assigned functions in accordance with the mode of system operation (e.g., displaying different views). Therefore, each of the multi-function controls 184 may be configured to provide a plurality of different actions. Label display areas 186 associated with the multi-function controls 184 may be included as necessary on the display 118. The system 176 may also have additional keys and/or controls 188 for special purpose functions, which may include, but are not limited to “freeze,” “depth control,” “gain control,” “color-mode,” “print,” and “store.”

One or more of the label display areas 186 may include labels 192 to indicate the view being displayed or allow a user to select a different view of the imaged object to display. For example, the labels 192 may indicate an apical 4-chamber view (a4ch), an apical long axis view (alax) or an apical 2-chamber view (a2ch). The selection of different views also may be provided through the associated multi-function control 184. For example, the a4ch view may be selected using the multi-function control F5. The display 118 may also have a textual display area 194 for displaying information relating to the displayed image view (e.g., a label associated with the displayed image).

It should be noted that the various embodiments may be implemented in connection with miniaturized or small-sized ultrasound systems having different dimensions, weights, and power consumption. For example, the pocket-sized ultrasound imaging system 176 and the miniaturized ultrasound system 130 of FIG. 2 may provide the same scanning and processing functionality as the system 100 (shown in FIG. 1).

FIG. 4 illustrates a portable ultrasound imaging system 145 provided on a movable base 147. The portable ultrasound imaging system 145 may also be referred to as a cart-based system. A display 118 and user interface 124 are provided and it should be understood that the display 118 may be separate or separable from the user interface 124. The user interface 124 may optionally be a touchscreen, allowing the operator to select options by touching displayed graphics, icons, and the like.

The user interface 124 also includes control buttons 152 that may be used to control the portable ultrasound imaging system 145 as desired or needed, and/or as typically provided. The user interface 124 provides multiple interface options that the user may physically manipulate to interact with ultrasound data and other data that may be displayed, as well as to input information and set and change scanning parameters and viewing angles, etc. For example, a keyboard 154, trackball 156 and/or multi-function controls 160 may be provided.

Various embodiments of the invention provide one or more methods for aligning slices to different views of an imaged object. It should be noted that although the various embodiments are described below in connection with displayed image views of a heart, the various embodiments may be used to align slices to views of different imaged objects, for example, of different organs. Also, although the various embodiments may be described herein in connection with an ultrasound imaging system, the various embodiments may be implemented in connection with different diagnostic imaging systems for imaging human and non-humans. For example, the various embodiments may be implemented in connection with a computed tomography (CT) system or a magnetic resonance imaging (MRI) system.

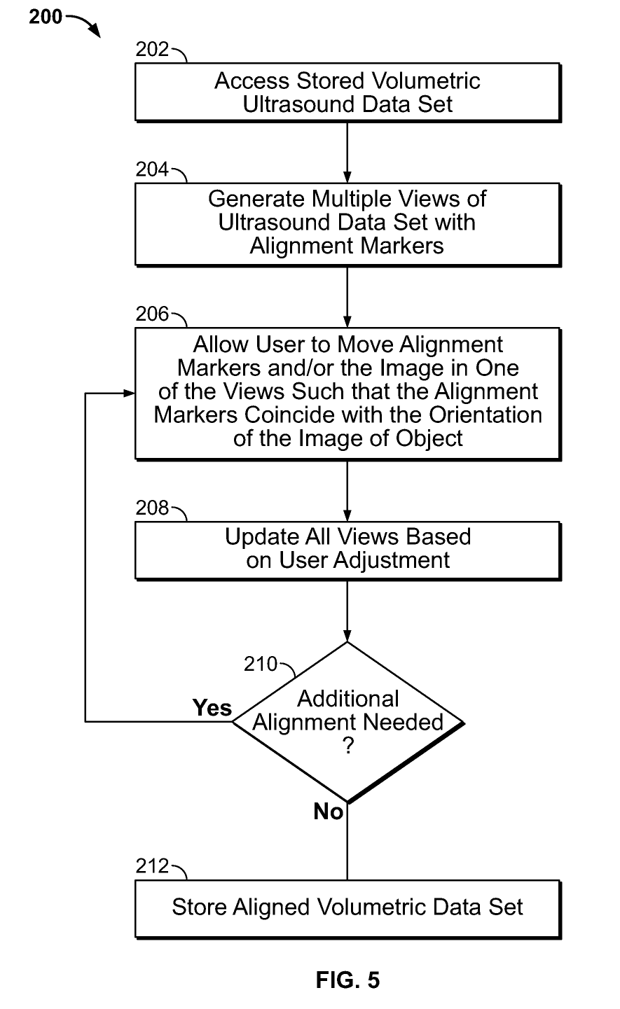

Specifically, and as shown in FIG. 5, a method 200 for aligning slices to different views of imaged object within a volumetric data set (e.g., a volumetric ultrasound data set) includes accessing a stored volumetric data set at 202. This may include accessing a stored ultrasound data set, such as, a volumetric data set of an imaged heart. Thereafter, multiple views of the volumetric data set are displayed with alignment markers at 204. For example, alignment markers may be provided as overlays on the different displayed image views. The image views may be the standard views of a heart that are normally recorded during typical 2D echo examinations. For example, the imaged views may be the three standard apical views of the left ventricle of the heart including the 4-chamber apical view, the long axis apical view and the 2-chamber apical view. Additional views may be generated, for example, a short axis view. Alternatively, a plurality of short axis views may be generated.

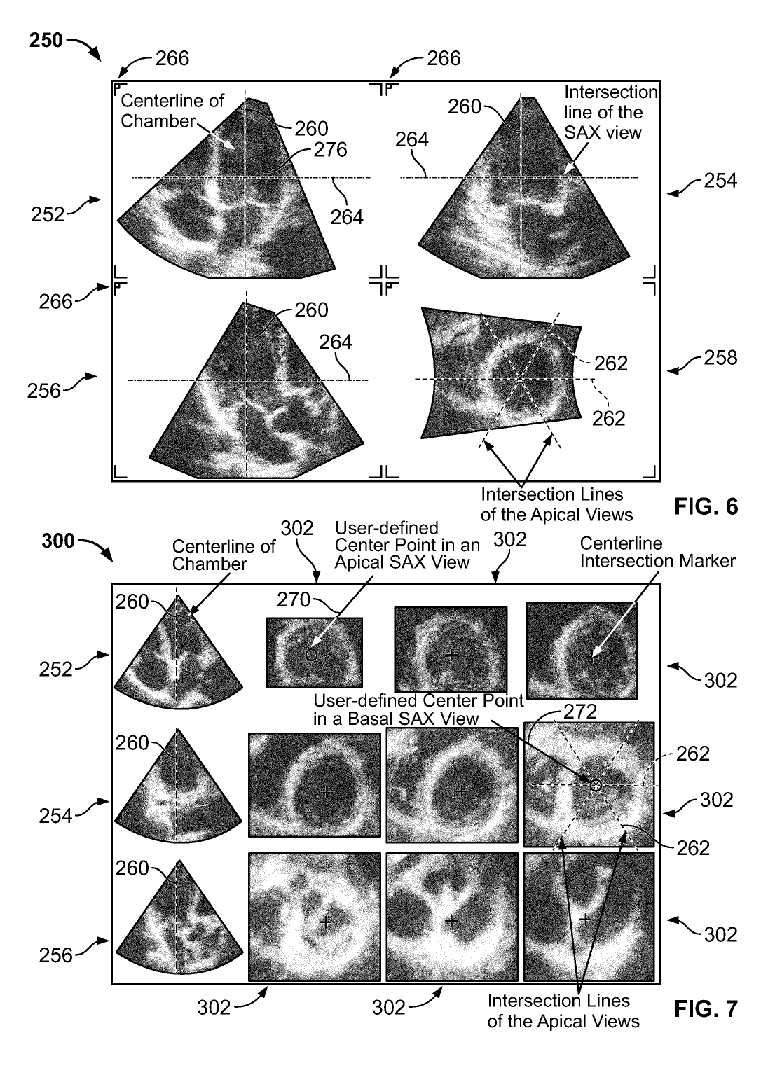

In particular, in one embodiment, as shown in FIG. 6, a quad view 250 of a heart may be displayed showing a 4-chamber apical view 252, a 2-chamber apical view 254, a long axis apical view 256 and a short axis view 258. In this embodiment, before the user starts the alignment procedure, the azimuth plane may be used as the 4-chamber apical view 252. The 2-chamber apical view 254 and the long axis apical view 256 may be generated by rotating sixty degrees and 120 degrees, respectively, relative to the original 4-chamber apical view 252.

Alternatively, a display 300 as shown in FIG. 7 may be displayed having a plurality of short axis views 302, for example, nine short axis views 302. The short axis views 302 in one embodiment are evenly distributed along a rotation axis or centerline marker 260 of the apical views and intersects major parts of the object of interest. Additionally, the 4-chamber apical view 252, the 2-chamber apical view 254 and the long axis apical view 256 also optionally may be displayed.

The various views are displayed in connection with one or more alignment markers that may be predefined or user defined. For example, as shown in FIGS. 6 and 7, a centerline marker 260 may be displayed (e.g., a dashed line overlay) on each of the 4-chamber apical view 252, the 2-chamber apical view 254 and the long axis apical view 256. The centerline markers 260 represent the rotation axis of the three apical views. Additionally, intersection lines 264 represent the intersection between the short axis view 258 and each apical view. Further, the intersection lines 262 (e.g., dashed lines) may be provided on the short axis view 258, identifying the intersection between the short axis view and each of the 4-chamber apical view 252, the 2-chamber apical view 254 and the long axis apical view 256. It should be noted that the intersection lines 262 may be color coded to correspond to a color indicator 266, for example, a colored box displayed in connection with each of the corresponding the 4-chamber apical view 252, the 2-chamber apical view 254 and the long axis apical view 256.

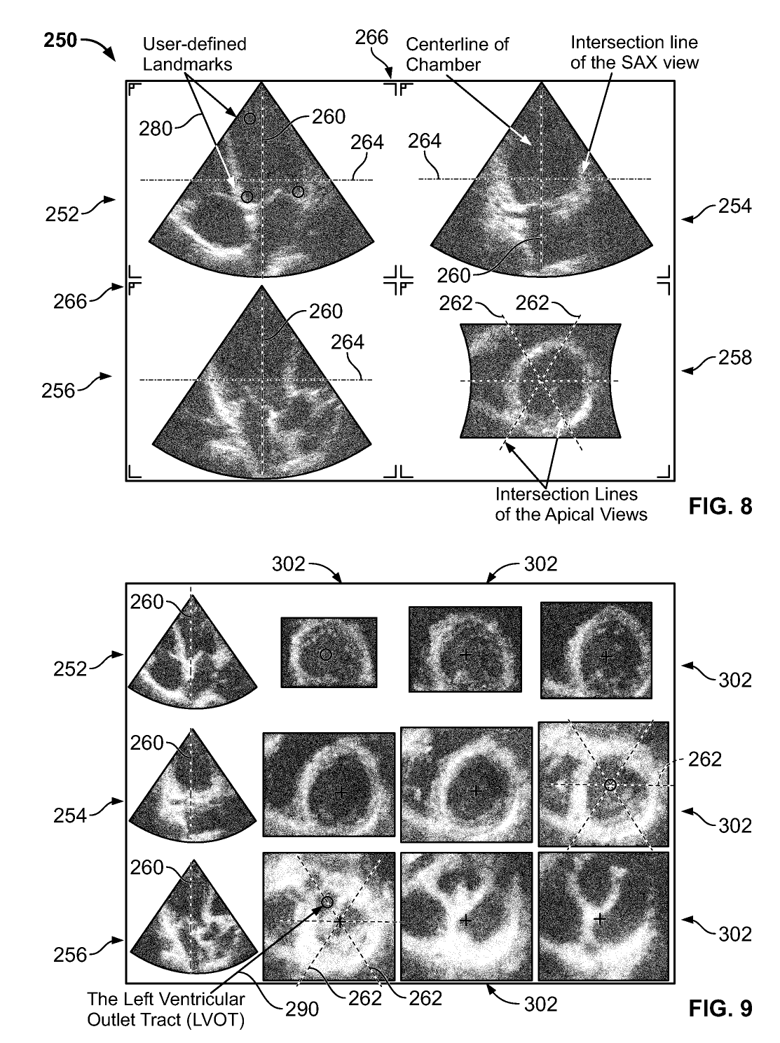

A user defined marker also may be provided. For example, as shown in FIG. 7, a user defined center point 270 in an apical short axis apical view 302 or a user defined center point 272 in a basal short axis view 302 may be provided. In these views, the user may use a pointing device to select, for example, identify center points 270 and 272. The center points 270 and 272 represent the intersection between the short axis views and the centerline marker 260. Additional or alternative center points may be identified in different short axis views 302. In another embodiment as shown in FIG. 8, a user may identify landmarks (e.g., apex and mitral valve ring) with markers 280 in the 4-chamber apical view 252 (or other views as described herein).

Referring again to FIG. 5, once the views are displayed with the alignment markers, at 206 a user may adjust one of the views to align the imaged object with the alignment marker displayed in connection therewith. For example, as shown in FIG. 6, a user may rotate (e.g., tilt or rotate clockwise or counterclockwise) the image displayed in the 4-chamber view 252 such that the centerline marker 260 is aligned with the center of the left ventricle 276 of the displayed heart. Thereafter, the user may translate the displayed image view (e.g., shift the image left or right as shown in FIG. 6) to align the center of the left ventricle 276 with the centerline marker 260. The order of user actions may be changed, for example, such that the translation is performed before the rotation. Multiple such iterations of the adjustments may be performed in any order. The user also may move the intersection line 264 upward and downward relative to the centerline marker 260 to align the intersection line 264 with the mitral valve of the displayed heart. The intersection line 264 is maintained perpendicular to the centerline marker 260. Thus, the short axis view 258 is maintained perpendicular to the 4-chamber apical view 252, the 2-chamber apical view 254 and the long axis apical view 256.

Once the 4-chamber apical view 252 is adjusted, the other views, namely, the 2-chamber apical view 254, the long axis apical view 256 and the short axis view 258 are updated accordingly at 208, for example, translated or rotated to maintain orientation with respect to the 4-chamber apical view 252. For example, the various apical views may be adjusted to maintain the previously defined degrees difference between each of the apical views.

Once all of the views have been updated, a determination is made at 210, for example, by the user, as to whether additional alignment is needed or desired, such as whether additional views are to be adjusted. For example, if the 4-chamber apical view 252 has been adjusted, and in particular, aligned, a user may wish to align additional views, for example, the 2-chamber apical view 254 and the long axis apical view 256. If additional views are to be adjusted, the method 200 returns to 206 for adjustment of the additional views. The order in which the views are adjusted may be changed and the first view adjusted may be any of the views. Additionally, not all views have to be adjusted.

The user may also use short axis views to adjust the image views. For example, as shown in FIG. 6, a user may rotate the apical intersection lines, namely the intersection lines 262, which will cause the 4-chamber apical view 252, the 2-chamber apical view 254 and the long axis apical view 256 to be updated to maintain the relative orientation as described above. The alignment provided by the display 250 shown in FIG. 6 is essentially an apical view based alignment of standard views. Using the short axis views 302 shown in FIG. 7, a short axis based alignment of the standard views also may be provided. For example, the short axis views 302 may be used to define the centerline of the left ventricle of the heart. For example, a user may identify the centerline positions in at least two short axis slices displayed by the short axis views 302 by selecting the center points 270 and 272. The center points 270 and 272 will then define the centerline through the left ventricle. For example, the center points 270 and 272 may be placed in an apical short axis view and a basal short axis view as described above. Once the center points 270 and 272 are identified (e.g., using a mouse), all of the short axis apical views 302 are updated such that the views are maintained parallel. The apical views are also updated (e.g., tilted/translated) such that the rotation axis for each coincides with the centerline defined by the two center points 270 and 272. The user may also rotate the apical intersection lines 262 in one of the short axis views 302 to thereby define the correct orientations for the 4-chamber apical view 252, the 2-chamber apical view 254 and the long axis apical view 256.

It should be noted that optionally, a user may identify the aortic valve region as shown in FIG. 9. For example, a user may identify with a circle marker 290 the left ventricular outlet tract (LVOT). The other short axis views 302 are updated accordingly as described herein. The LVOT may be used, for example, to define the correct orientation of the apical long view (intersection line 264) and the depth of the mitral valve region.

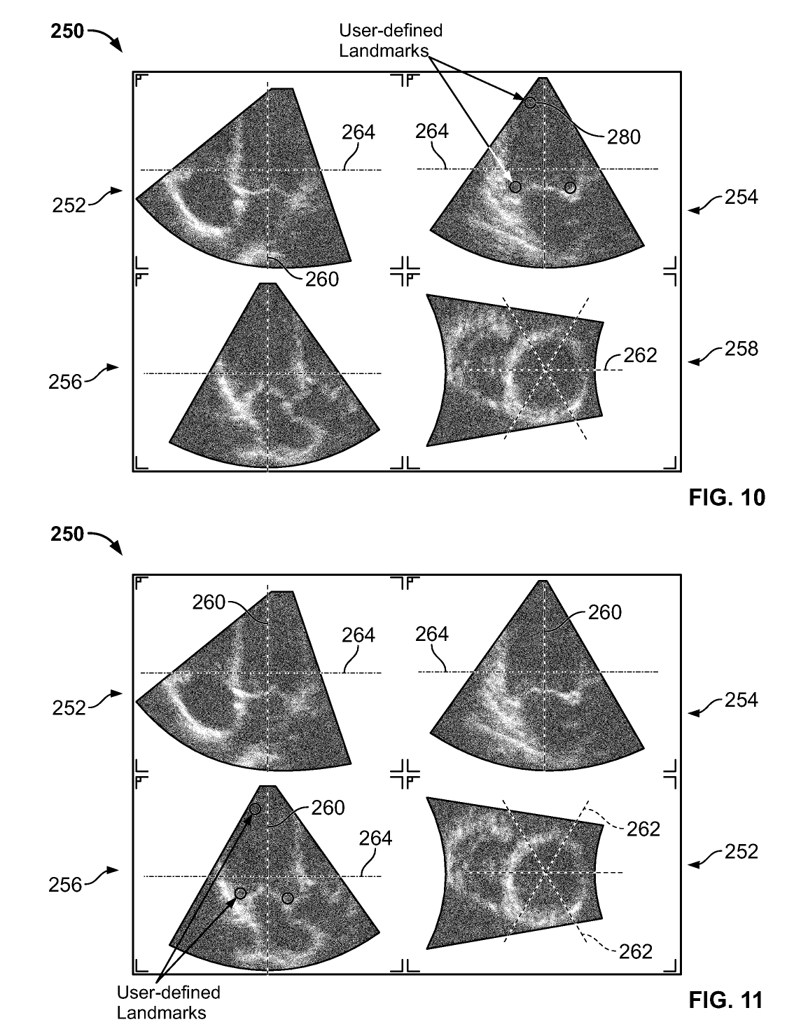

A user may also identify landmarks on each of the 4-chamber apical view 252, the 2-chamber apical view 254 and the long axis apical view 256 as shown in FIG. 8. For example, as described above, anatomical landmarks (e.g., apex and mitral valve annulus) may be identified with markers 280 in the 4-chamber apical view 252. Thereafter, the landmarks may be identified in each of the 2-chamber apical view 254 and the long axis apical view 256. It should be noted that after the markers 280 are selected, the centerline marker 260 is adjusted and positioned through the apex point and the average point between the two annulus points defining the mitral valve annulus. The image views will thereafter update automatically (e.g., translate and rotate automatically) such that the common rotation axis is equivalent to the new centerline estimate, for example, as shown from FIG. 9 to FIG. 10.

The landmarks then may be identified in the 2-chamber view 254 as shown in FIG. 10 and the view updated as shown in FIG. 11. The landmarks then may be identified in the long axis apical view 256 as shown in FIG. 11 with the view updated as described herein. Rotation of the intersection lines 262 in the short axis view 258 also may be performed as described above.

Referring again to FIG. 5, the aligned volumetric data set then may be stored at 212. The aligned volumetric data also may be used by other processes, for example, to perform automatic volume measurements or to generate volume renderings of the standard views of the heart.

It should be noted that the slice alignment of the various embodiments may be used in connection with still images/frames or moving images/frames (e.g., cine loop images).

Thus, various embodiments of the invention provide slice alignment to different user-defined views of an imaged object within a volumetric data set, for example, an ultrasound volumetric data set. A technical effect of at least one embodiment is the efficient and robust definition of the left ventricular centerline and standard views of a heart by using markers in different views. The standard view positions then may be used, for example, to define volume renderings or special screen presentations (e.g., layouts) that are adjusted to specific clinical applications (e.g., wall motion analysis and assessment of a mitral morphology). Apical foreshortening is reduced or eliminated and measurements from automatic volume segmentation methods become more reproducible.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

What is claimed is:

1. A method for slice alignment in a volumetric data set, the method comprising:
determining an adjustment of one of a plurality of image views to align an imaged object with at least one alignment marker, the adjustment including at least one of (i) rotating the one image view with respect to an intersection of the at least one alignment marker with another alignment marker and (ii) translating the one image view; and
updating the plurality of image views based on the adjustment.

2. A method in accordance with claim 1 wherein the at least one alignment marker is a centerline marker and the other alignment marker is an intersection line and further comprising maintaining the intersection line perpendicular to the centerline marker.

3. A method in accordance with claim 1 wherein the plurality of image views comprise a plurality of views of a heart including a 4-chamber apical view, a 2-chamber apical view, a long axis apical view and a short axis view and wherein the alignment marker is a centerline marker that represents the intersection of the apical views.

4. A method in accordance with claim 1 wherein the at least one alignment marker represents a centerline of a left ventricle of a heart.

5. A method in accordance with claim 4 wherein the other alignment marker represents a view at a level of a mitral valve annulus of a heart, wherein the mitral valve annulus view is maintained perpendicular to the centerline marker and the updating includes only translating the mitral valve annulus marker along a direction of the centerline marker and not rotating the mitral valve annulus marker.

6. A method in accordance with claim 1 wherein the plurality of image views comprise a plurality of views of a heart including a 4-chamber apical view, a 2-chamber apical view, a long axis apical view and a short axis view, and further comprising a plurality of intersection lines in combination with the short axis view and corresponding to the apical views and further comprising rotating the apical views about a centerline.

7. A method for slice alignment in a volumetric data set of an imaged heart, the method comprising:
displaying a plurality of apical views of the heart in combination with a plurality of alignment markers;
displaying a plurality of short axis views of the heart, at least some of the plurality of short axis views displayed in combination with alignment markers; and
updating the plurality of apical views and short axis views based on a user identified center point in at least two of the short axis apical views.

8. A method in accordance with claim 7 wherein the alignment markers displayed in combination with the apical views comprise centerline markers and the alignment markers displayed in combination with the short axis views comprise center point markers.

9. A method in accordance with claim 8 wherein the center point markers in the short axis views correspond to an intersection of the apical views and further comprising maintaining the centerline perpendicular to the short axis views.

10. A method in accordance with claim 7 wherein the at least two short axis views comprise an apical short axis view and a basal short axis view.

11. A method in accordance with claim 7 further comprising providing a fixed relation between the plurality of apical views.

12. A method in accordance with claim 7 wherein the plurality of views comprise a 4-chamber apical view, a 2-chamber apical view, a long axis apical view and at least two short axis views and wherein the alignment markers displayed in combination with the plurality of apical views is a centerline marker that represents the intersection of the apical views.

13. A method in accordance with claim 12 further comprising rotating the apical views about the centerline marker based on a user identified left ventricular outlet tract in at least one of the short axis views.

14. A method in accordance with claim 7 wherein the updating comprises at least one of translating and rotating.

15. A method in accordance with claim 7 wherein the plurality of views comprise a 4-chamber apical view, a 2-chamber apical view, a long axis apical view and at least two short axis views and wherein the plurality of alignment markers displayed in combination with at least one of the short axis views correspond to the apical views and further comprising rotating the apical views about a centerline.

16. A method for slice alignment in a volumetric data set of an imaged heart, the method comprising:
displaying a plurality of apical views of the heart in combination with a plurality of alignment markers; and
updating the plurality of apical views based on user identified landmarks.

17. A method in accordance with claim 16 wherein the user identified landmarks comprise an apex of a left ventricle of the heart and the mitral annulus of the left ventricle and wherein at least one of the alignment markers corresponds to a line extending from the apex to a middle of the mitral annulus.

18. A method in accordance with claim 16 wherein the updating comprises at least one of translating and rotating.

19. A method in accordance with claim 16 wherein the plurality of views comprise a 4-chamber apical view, a 2-chamber apical view, a long axis apical view and a short axis view and wherein the plurality of alignment markers displayed in combination with the short axis view correspond to the apical views and further comprising rotating the apical views about a centerline.

20. An ultrasound system comprising:
an ultrasound probe for acquiring a volumetric ultrasound data set of a heart; and
a processor having a slice alignment module configured to automatically align a plurality of views of the volumetric data set based on at least one of (i) a centerline alignment marker and a perpendicular intersection marker rotated about the intersection of the centerline marker and the perpendicular intersection marker in one of a 4-chamber apical view of the heart, a 2-chamber apical view of the heart and a long axis apical view of the heart, (ii) an identified center point in at least two short axis views of the heart, (iii) an identified left ventricular outlet tract in a short axis view of the heart, and (iv) a plurality of identified landmarks corresponding to a mitral annulus and an apex of a left ventricle of the heart.
